(19) United States
(12) Patent Application Publication
(10) Pub. No.: US 2016/0185066 A1
(43) Pub. Date: Jun. 30, 2016

(54) MODULAR CASE ERECTOR

(71) Applicant: DOUGLAS MACHINE INC., Alexandria, MN (US)

(72) Inventor: Joshua J. Klein, Sauk Centre, MN (US)

(73) Assignee: DOUGLAS MACHINE INC., Alexandria, MN (US)

(21) Appl. No.: 14/930,071

(22) Filed: Nov. 2, 2015

Related U.S. Application Data
(60) Provisional application No. 62/073,265, filed on Oct. 31, 2014.

(51) Int. Cl. B31B 1/80; B31B 1/02

(52) U.S. Cl. CPC B31B 1/80; B31B 1/02; B31B 2201/288; B31B 2201/60; B31B 2201/0235

(57) ABSTRACT

An improved case setup station in/for a case erector is provided. The station includes a transfer assembly, an actuatable a case blank clamp, and a case blank expander. The transfer assembly secures a vertically oriented case blank from a supply of vertically oriented case blanks and delivers same to the case blank clamp while maintaining a vertical orientation for the case blank. The clamp is downstream from the supply of vertically oriented case blanks and extends in a process flow direction for holding a delivered case blank, the clamp is characterized by first upstream and second down stream vacuum cup pairs, a first surface of a delivered case blank engaged by the vacuum cup pairs. The expander is adjacent the clamp, and is actuatable so as to travel towards and away from a held case blank of the clamp. The expander is securable to a second surface of the delivered case blank held by the clamp during a first actuation motion, the second surface of the delivered case blank held by the clamp pulled away from the first surface of the delivered case blank held by the clamp during a second actuation motion.

This is a United States national patent application filed pursuant to 35 USC §111(a) claiming priority under 35 USC §120 of/to U.S. Pat. Appl. Ser. No. 62/073,265 filed Oct. 31, 2014 and entitled MODULAR CASE ERECTOR, the disclosure of which is hereby incorporated by reference in its entirety.

### TECHNICAL FIELD

The present invention generally relates to packing equipment, more particularly, to automated case erecting and/or case erecting and forming, and more particularly still to a modular apparatus or assembly for at least automatically erecting and forming a case from a case blank.

### BACKGROUND OF THE INVENTION

Owing to numerous factors such as low cost, light weight and recycleability, cardboard boxes or cases are supremely convenient and thus ubiquitous. While cardboard cases have evolved, for instance, into transport, display and dispensing devices for articles packed therein, as is evidenced by walking the isles of many super stores or the like, the inherent nature of the case, exclusive of its highly variable configuration, nonetheless remains. More particularly, cardboard boxes or cases are commercially available, business-to-business, in a folded flat condition (i.e., a “flattened” or “knockdown” condition, akin to a flattened sleeve) as a blank, with manipulations characterized by expansion and flap folding/tucking/sealing required to transfer the blank into a case.

In advance of further narrative, the topic of case type and/or configuration merits attention. Form generally fits function. The most common cardboard box or case used in packaging/shipping is the Regular Slotted Case (RSC) owing to its cost effectiveness.

The RSC is characterized by opposing major and opposing minor panels. Major and minor flaps extend or depend from each major and minor panel respectively. Moreover, the major flaps run the length of the box with the two minor flaps at each end. The major flaps overlie the folded minors, and meet in the center when folded.

Further non-limiting exemplary case types include All Flaps Meet (AFM) wherein first folded minors meet in the center and overlaying majors likewise meet in the center to create an especially strong, smooth bottomed box; and, Half Slotted Case (HSC) wherein flaps are absent from a “top” or “bottom” of the case, i.e., the HSC is essentially an RSC without top flaps, this style oftentimes is combined with a lid during transport. Variants of the RSC and HSC are also known, namely, those referred to as HSC with Display, Five Panel RSC or HSC, with or without display, and an RSC adapted to have a user foldable “locking” top (e.g., intermeshing top flaps).

Finally, knockdowns are manufactured in two configurations, namely left and right handed. The relationship between the major and minor panels of a knockdown case determine its “handedness,” i.e., in elevation view, a minor panel adjacent to the right of the major panel (i.e., major panel “left”) is a left hand configuration; a minor panel adjacent to the left (i.e., major panel “right”) is a right hand configuration.

A particularly instructive depiction with regard to cases/case formation is FIG. 14 of U.S. Pat. No. 7,390,291 (Chiu Chen), that figure is explicitly incorporated herein as FIG. 1, and is labeled as “BACKGROUND.” Each of the cases (C) are formed from a blank (B), more particularly, a lefthand regular slotted case (LHRSC) blank as shown. While the case is characterized by opposing major and minor walls, W_{M} and Wₘ respectively, and opposing major and minor base portions, B_{M} and Bₘ respectively, each depending from opposing major and minor walls, W_{M} and Wₘ respectively, the blank is characterized by first and second panels, P1 & P2 respectively, each panel including major and minor panels P_{M} and Pₘ, which correlate with/to major and minor case walls W_{M} and Wₘ, with the panels of the blank further including major and minor flaps, F_{M} and Fₘ respectively, each extending from opposing sides of the major and minor panels P_{M} and Pₘ respectively. Major and minor flaps F_{M} and Fₘ of blank B correlate with/to opposing major and minor base portions B_{M} and Bₘ of case C.

A case erector is generally understood to be a device that takes a blank from a supply of blanks (i.e., a magazine) and unfolds it (i.e., it is a device for executing a mechanized forming operation as per FIG. 1 of the like). In connection to unfolding the blank, flap folding/tucking/sealing commences in furtherance of establishing what is essentially a case floor or roof, the semantic a function of article loading approach.

Presently, efforts are primarily and generally directed to greater processing speeds without an increase of downtime/spoilage owing to jams and less than optimal case erection (e.g., lack of squaring) and/or sealing. Moreover, the proverbial, highly sought after, one size fits all approach in relation to an apparatus capable of processing left hand and right hand cases in either of right or left hand blank expansion operations has remained an emphasis.

For example, Frank et al. (U.S. Pat. No. 6,913,568) disclose separate arms securable to adjacent case blank panels (FIG. 1), arms which are operatively linked via a parallelogram linkage to cooperatively move, one relative to another (e.g., FIG. 2), to erect a case. Chiu Chen (U.S. Pat. No. 7,390,291) likewise provides separate arms securable to adjacent case blank panels (FIG. 8), arms which are operatively linked via a curved guide rail such that a minor case blank panel arm is pivoted in relation to a stationary major case blank panel arm (FIG. 9). Goodman (U.S. Pat. No. 7,510,517) discloses first and second orthogonally arranged arms, each equipped with a translatable vacuum head (FIG. 1). The vacuum heads are securable to major panels of opposing panels of a case blank, and thereafter translated in furtherance of expanding the case blank. Johnson et al. (U.S. Pat. No. 7,788,881) discloses a planar bearing surface defining a semicircular channel about a center point for two arms (FIG. 1) such that the arms are centrally united to receive a blank (FIG. 4), and thereafter, the arms are guidingly spread apart in fan-like fashion (FIG. 5) in furtherance of case erection. Finally, Ditmer et al. (U.S. Pat. No. 9,126,380) disclose a pneumatically driven assembly characterized by a picker arm and erector arm (FIG. 3), united by a complex hinge apparatus (FIG. 4), more particularly, a highly mechanized reversibly mounted assembly, for change over between “A” (FIG. 11) & “B” (FIG. 12) case types, is provided.

While improvements/advancements have no doubt been made, the nature of the technical improvements advanced have often times required substantial and significant capital expenditure by producers of cased articles. While higher throughputs, greater reliability, improved processing versatility and less down time are worthy aims, automated case erectors so characterized need not be complex, unwieldy and expensive. Thus, it is believed desirable and advantageous to offer an improved automated case erector characterized by elegant simplicity, for example, one characterized by minimal drivers and modularity.

### SUMMARY OF THE INVENTION

An improved case setup station in/for a case erector is provided. The station includes a transfer assembly, a case blank clamp, and an actuatable case blank expander. The transfer assembly secures a vertically oriented case blank from a supply of vertically oriented case blanks and delivers same to the case blank clamp while maintaining a vertical orientation for the case blank. The clamp is downstream from the supply of vertically oriented case blanks and extends in a longitudinal or process flow direction for holding a delivered case blank, the clamp is characterized by first upstream and second downstream vacuum cup pairs, a first surface of a delivered case blank engaged by the vacuum cup pairs. The expander is adjacent the clamp, and is actuatable so as to travel towards and away from a held case blank of the clamp. The expander is securable to a second surface of the delivered case blank held by the clamp during a first actuation motion, the second surface of the delivered case blank held by the clamp pulled away from the first surface of the delivered case blank held by the clamp during a second actuation motion.

In a first embodiment, the actuatable case expander is generally and fairly characterized as a linear open set up. Briefly, travel towards and away from a held case blank of the case blank clamp by the actuatable case blank expander is exclusively characterized by a transverse travel direction component. The case blank clamp is likewise actuatable, namely, longitudinally translatable, the cooperative actuation of each of the case expander and the clamp effectuating case blank expansion. Both right and left handed case set ups and clockwise and counterclockwise case opening enabled by the open set up.

In a further embodiment, the actuatable case expander is generally and fairly characterized as an arc open set up. Briefly, travel towards and away from a held case blank of the case blank clamp by the actuatable case blank expander is characterized by both of a transverse travel direction component and a longitudinal travel direction component. The case blank clamp is fixed, the expander motions essentially effectuating case expansion. Both right and left handed case set ups and clockwise and counterclockwise case opening enabled by the open set up.

Assemblies and/or subassemblies of/for both of a case set up area or station and a case sealing area or station are advantageously offered as discrete modules. Towards that end, an advantageously configured frame assembly is provided, namely, an especially symmetrical frame assembly which permits assemblies and/or subassemblies to be easily configured, reconfigured, and/or replaced depending on the application. There are two main sections of this frame, the case opening station and the sealing station. The setup station is the frame for a magazine, the open setup (i.e., either of linear or arc modules), the flap folders and, the transfer assembly (i.e., pull setup elements). The sealing station portion of the frame bounds either of modular taper or modular compression glue assemblies.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a modular case erector for providing flexibility by being able to be reconfigured for many different case erecting applications.

Another object is to provide a modular case erector that can erect a case in either of the knockdown fold orientations in both the right hand and left hand orientations.

Another object is to provide a modular case erector that can use either glue or tape to seal formed cases.

Another object is to provide a modular case erector that can be directly coupled, close coupled, or standalone.

Another object is to provide a modular case erector that utilizes opposing cups to perform two different functions rack opening the case, and opening up major flaps to allow for minor flap folding.

Another object is to provide a modular case erector that performs with a minimal use of drives.

Another object is to provided an improved case erector that uses conventional components in a heretofore unseen elegant arrangement in furtherance of providing a low cost versatile and robust apparatus.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application. More specific features and advantages obtained in view of those features will become apparent with reference to the drawing figures and DETAILED DESCRIPTION OF THE INVENTION.

### BRIEF DESCRIPTION OF THE DRAWINGS

Various other objects, features and attendant advantages of the present invention will become fully appreciated as the same becomes better understood when considered in conjunction with the accompanying drawings, namely FIGS. 1-23 in which like reference characters designate the same or similar parts throughout the several views, and wherein:

FIG. 1 illustrates, figure left to right, a typical case or box erecting and flap folding process, more particularly, such process as applied to a Regular Slotted Case (RSC), more particularly, to a left handed RSC (i.e., LHRSC);

FIG. 2 depicts, perspective side (front) view slightly from above operational flow generally left to right, a non-limiting, advantageous case erector, namely, an erector characterized by an arc setup module and a taper module;

FIG. 3 depicts, perspective side (front) view slightly from above operational flow generally left to right, a further, alternate, non-limiting, advantageous case erector, namely an erector characterized by a linear setup module and gluer module;

FIG. 4 substantially depicts, side (front) elevation select structures omitted, the case erector of FIG. 3;

FIG. 5 depicts, end (downstream) elevation, the case erector of FIG. 3;

FIG. 6 depicts, alternate side (back) elevation, the case erector of FIG. 3 (i.e., a view opposite that of FIG. 4);

FIG. 7 substantially depicts, perspective side (front) view slightly from above, a frame assembly for the case erector of FIGS. 2 & 3;

FIG. 8 depicts, perspective side (front) view slightly from above operational flow left to right, an upstream most portion of the case erector of FIGS. 2 & 3, namely, a case blank magazine;

FIG. 9 depicts, perspective side (front) view slightly from below, a non-limiting advantageous transfer assembly of the case erector of FIGS. 2 & 3;

FIG. 10 depicts, side (front) elevation, the transfer assembly of FIG. 9;

FIG. 11 substantially depicts a case setup area/station of FIG. 3, namely, a case blank clamp and actuatable case blank expander, linear setup;

FIG. 12 depicts, overhead view operational flow left to right, the case setup area/station of FIG. 11;

FIG. 13 substantially depicts a case setup area/station of FIG. 2, namely, an alternate case blank clamp and actuatable case blank expander, arc setup;

FIG. 14 depicts, overhead view operational flow left to right, the case setup area/station of FIG. 13;

FIG. 15 depicts, perspective side (front) view slightly from above operational flow left to right, a flap folder/tucker subassembly of the case setup area/station of case erector of FIGS. 2 & 3;

FIG. 16 depicts, end elevation view, a sealing station of the case erector of FIG. 3, namely, a gluer module for sealing a formed case bottom;

FIG. 17 depicts, perspective side (front) view operational flow right to left, a sealing station of the case erector of FIG. 2, namely, a taper module for sealing a formed case bottom;

FIG. 18 depicts, perspective side (front) view slightly from above, a contemplated, non-limiting taper overhead assembly associated with the taper module of FIG. 17;

FIG. 19 depicts particulars of the taper overhead assembly as per area 18 of FIG. 18;

FIG. 20 depicts, perspective side (front) view slightly from above operational flow left to right, an exemplary case erecting, folding and tape sealing operation, namely, an operation characterized by a linear setup module and a taper module; and,

FIGS. 21-23 depict, overhead plan view, operational flow page top to page bottom, an operational sequence for case transfer and either of a clockwise or counterclockwise expansion for right and left handed cases, namely, operational flow sequences for each of, left to right: counterclockwise case opening with right hand arc expander; clockwise case opening with right hand actuatable clamp; counterclockwise case opening with left hand actuatable clamp; and clockwise case opening with left hand arc expander.

### DESCRIPTION OF PREFERRED EMBODIMENTS

In advance of taking up preferred embodiments and drawing particulars, several preliminary observations are offered to facilitate an understanding of the emphasis and scope of the instant disclosure, and its organization. In-as-much as particular attention is directed to specific functions part-and-parcel of case erecting, forming and sealing operations, namely, case erecting, a brief overview of top load case packing operations immediately follows, with an overview of the instant description following thereafter.

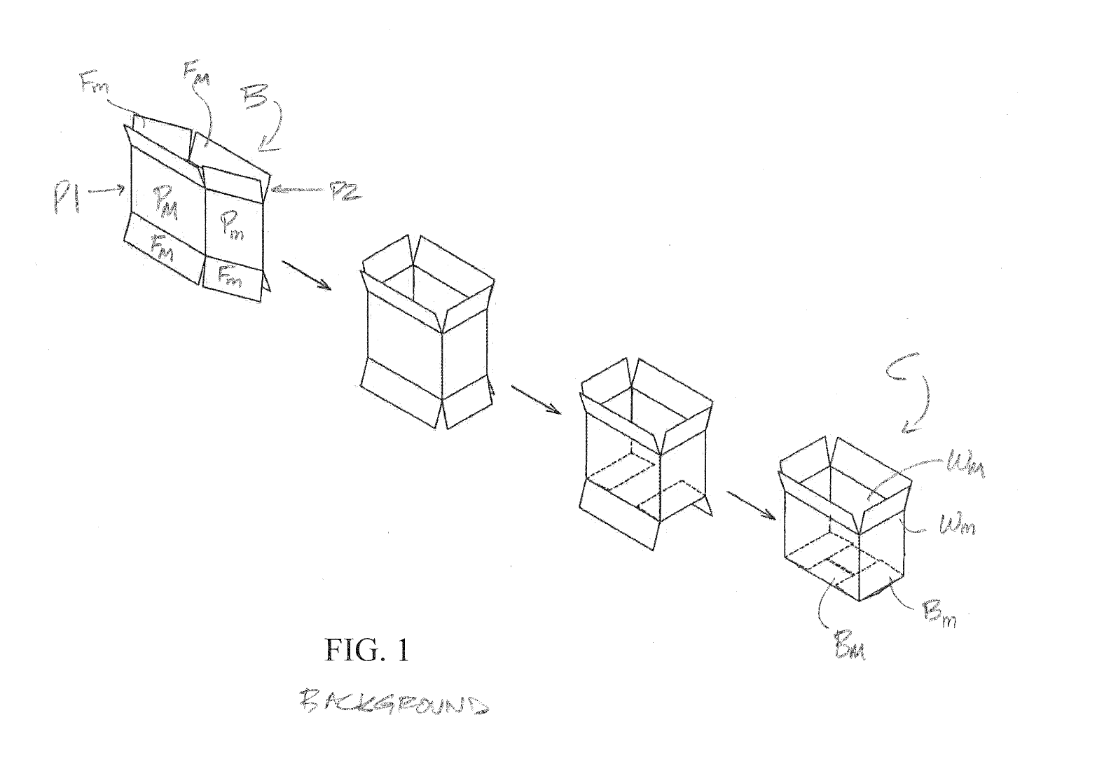

Generally, a supply of case blanks are provided in the form of a magazine, the magazine being selectively loadable by an operator. As was discussed in the background, and as will be later taken up, case type and case orientation are important variables, deterministic of mechanized erection solutions. A blank of the magazine is operated upon in furtherance of expanding same, i.e., the opposing sides or panels (i.e., P1, P2, of blank B (FIG. 1)) of the blank are pulled apart, with minor flaps initially folded, folded/tucked and major flaps thereafter folded, folded/tucked in furtherance of forming a case “bottom” (FIG. 1). Sealing operations are executed on a partially formed or fully formed case so as to unitingly secure the folded flaps to each other via a gluing step during case formation, or securing exterior flaps of the case bottom to each other and the case sidewalls or panels from which the tucked under flaps depend. Thereafter, the formed and securingly united case is commonly top loaded, with the flaps of the case “top” subsequently operated upon in furtherance of securingly united closure. The disclosure subsequently commences with respect to the aforementioned operational sequence.

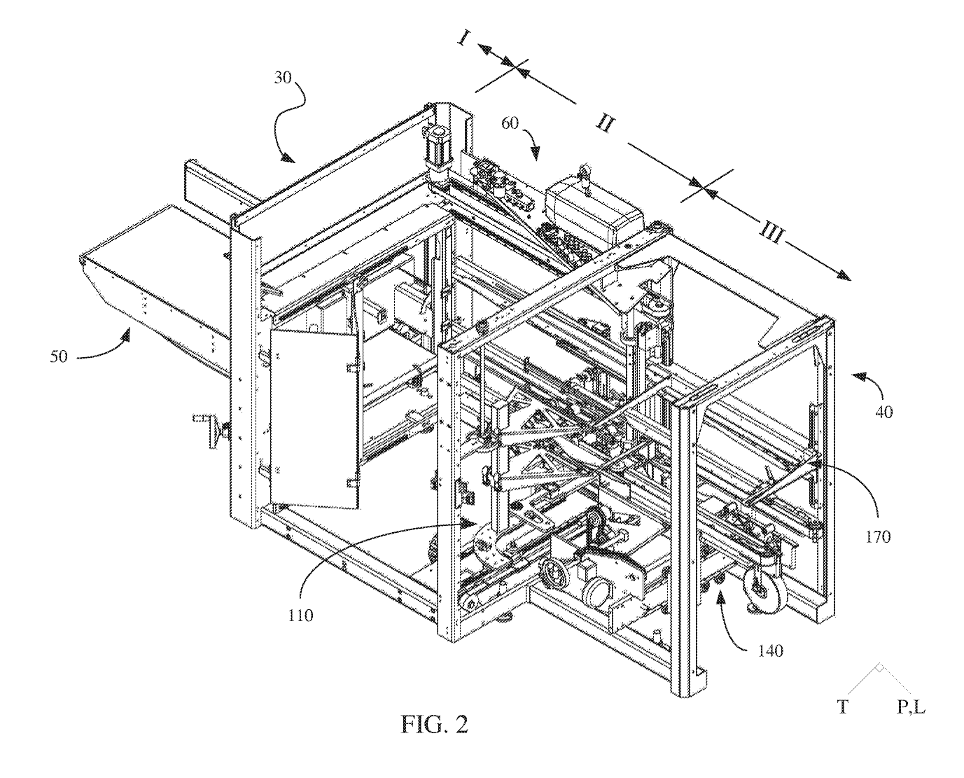

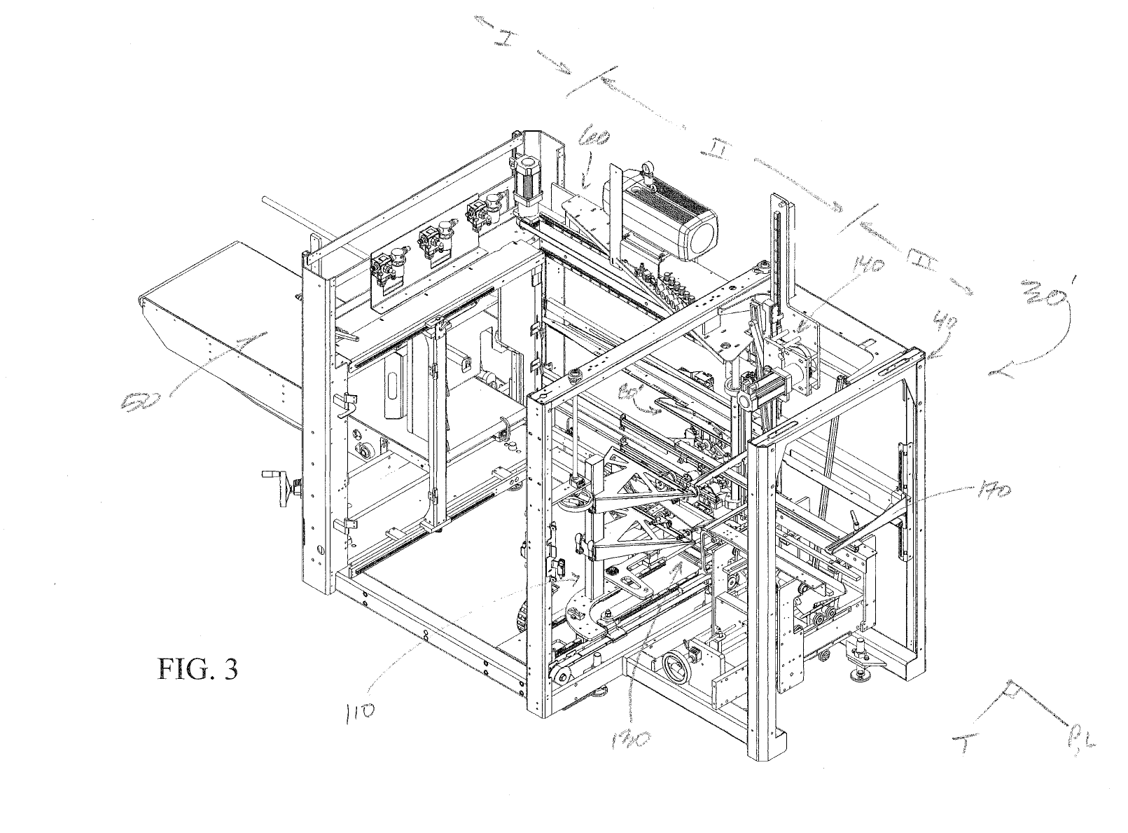

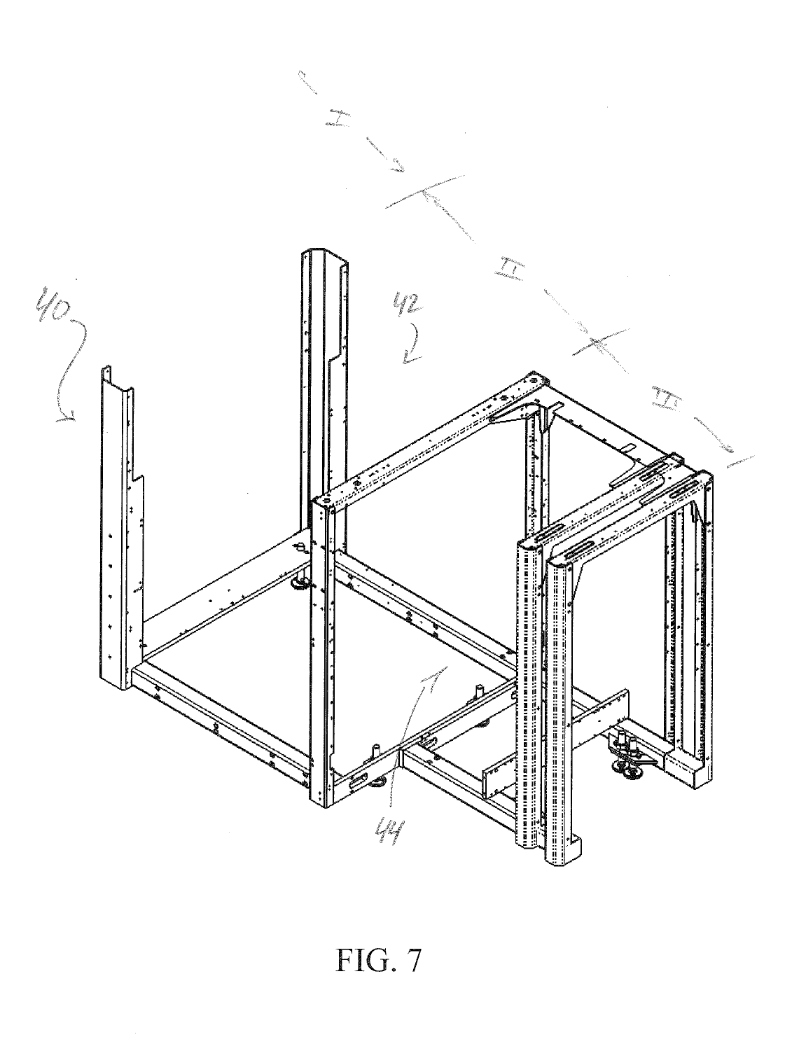

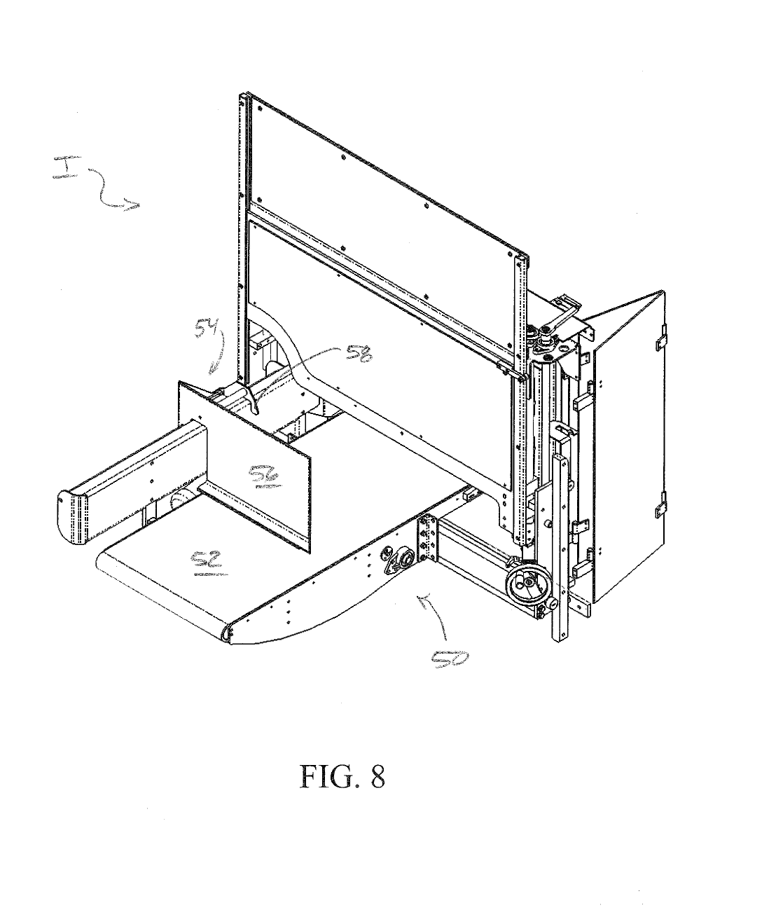

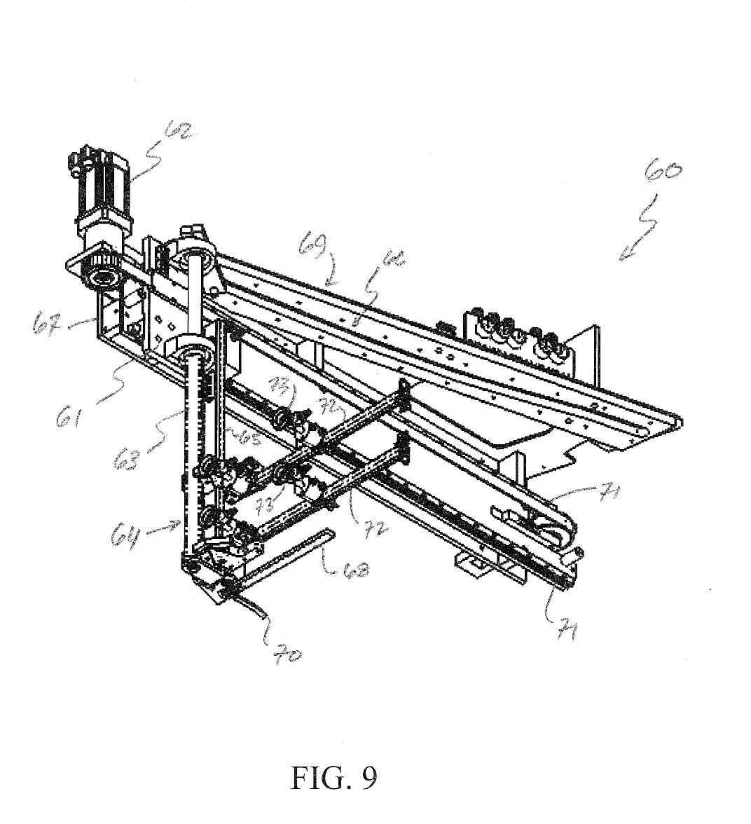

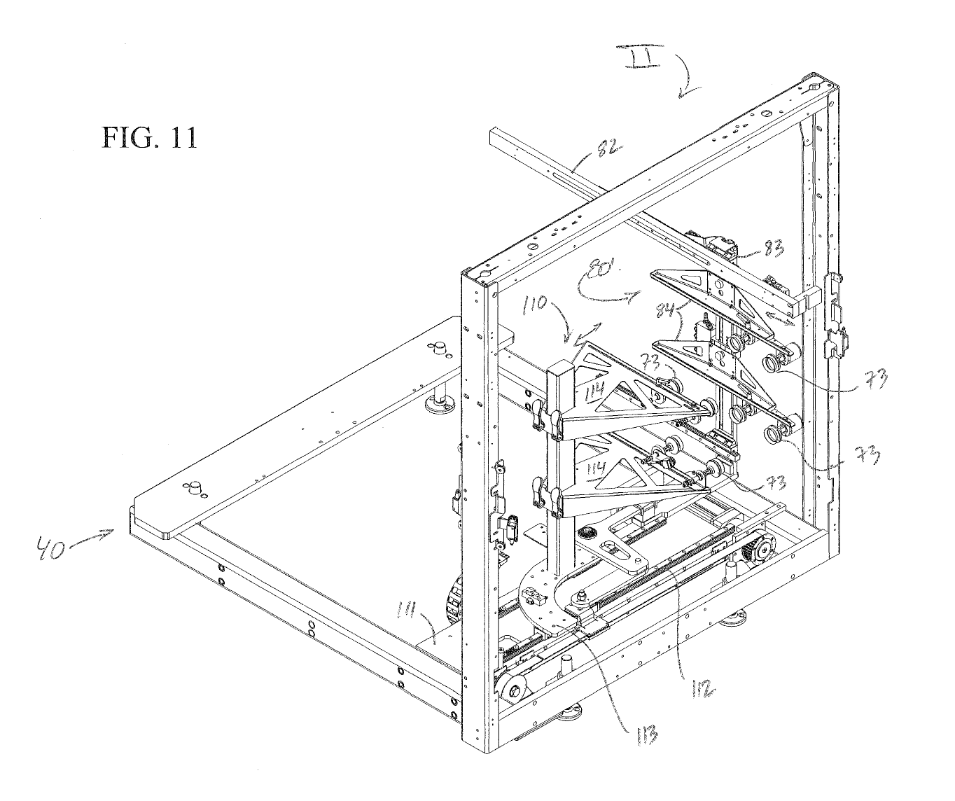

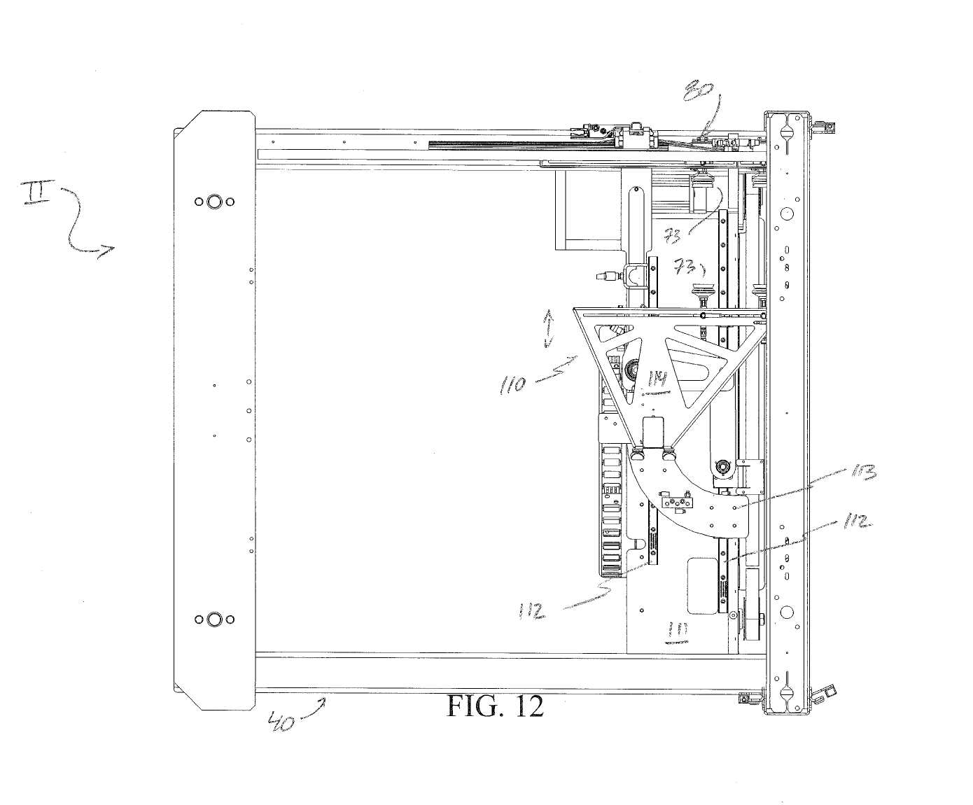

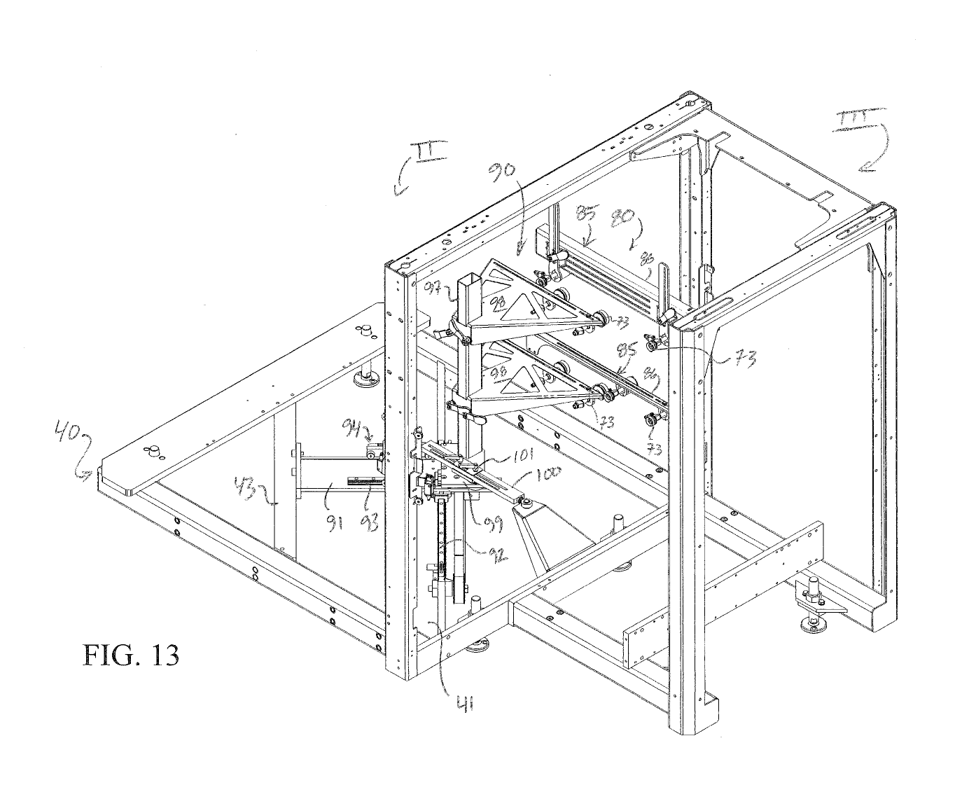

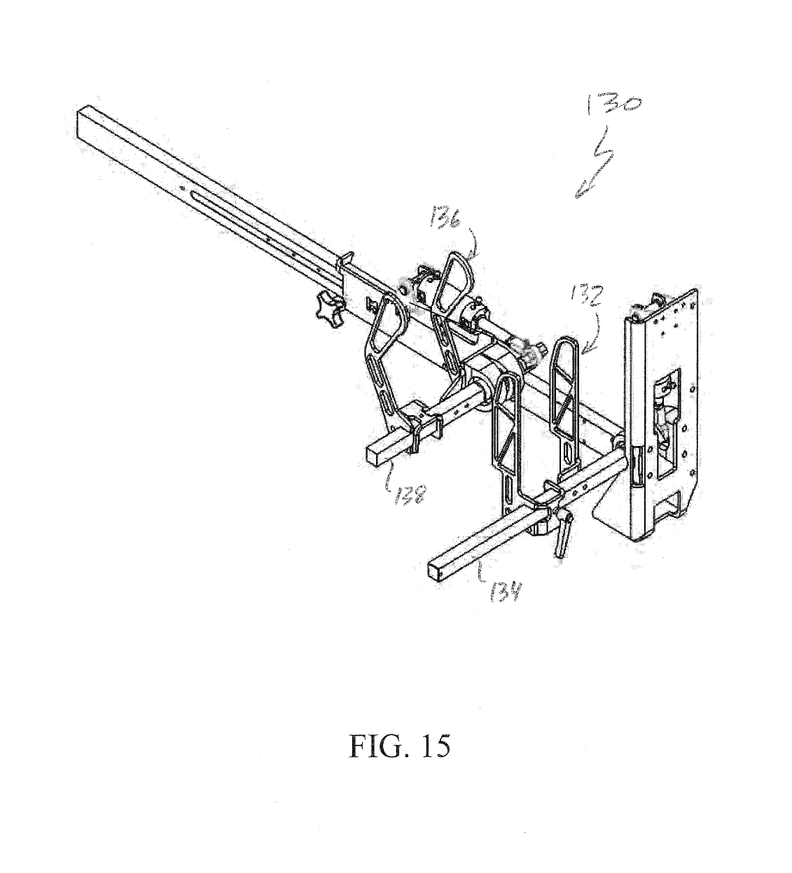

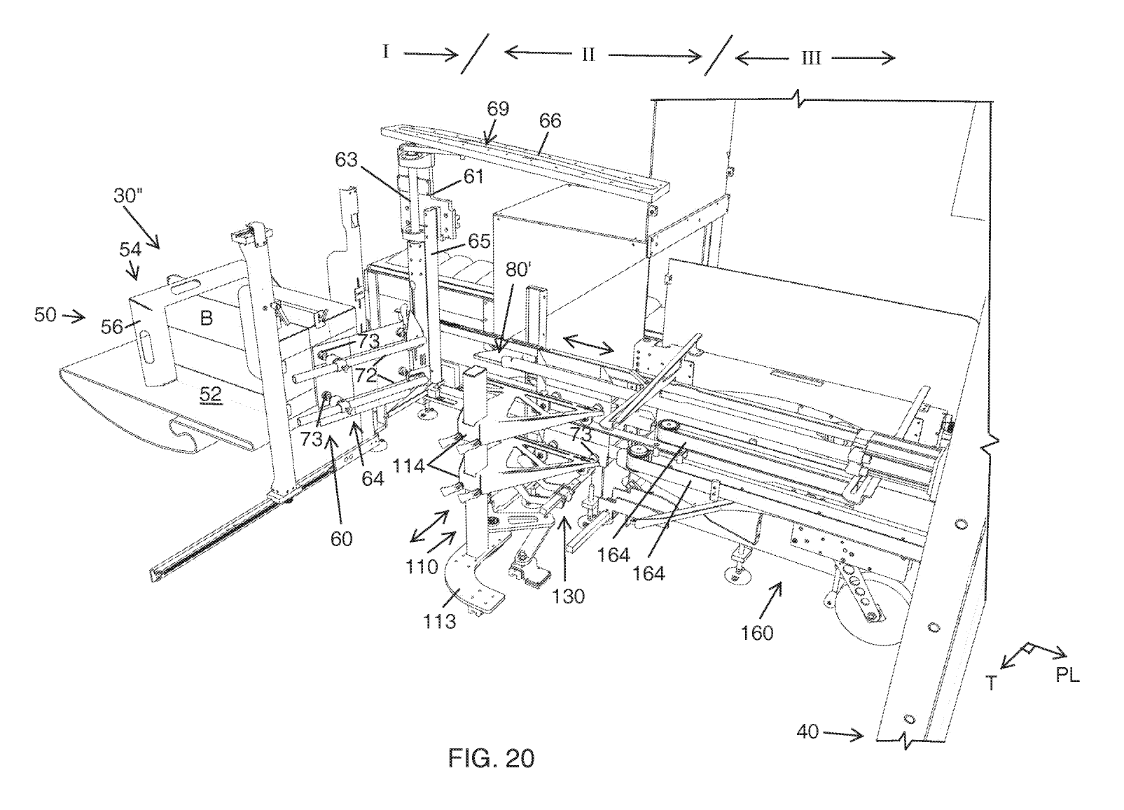

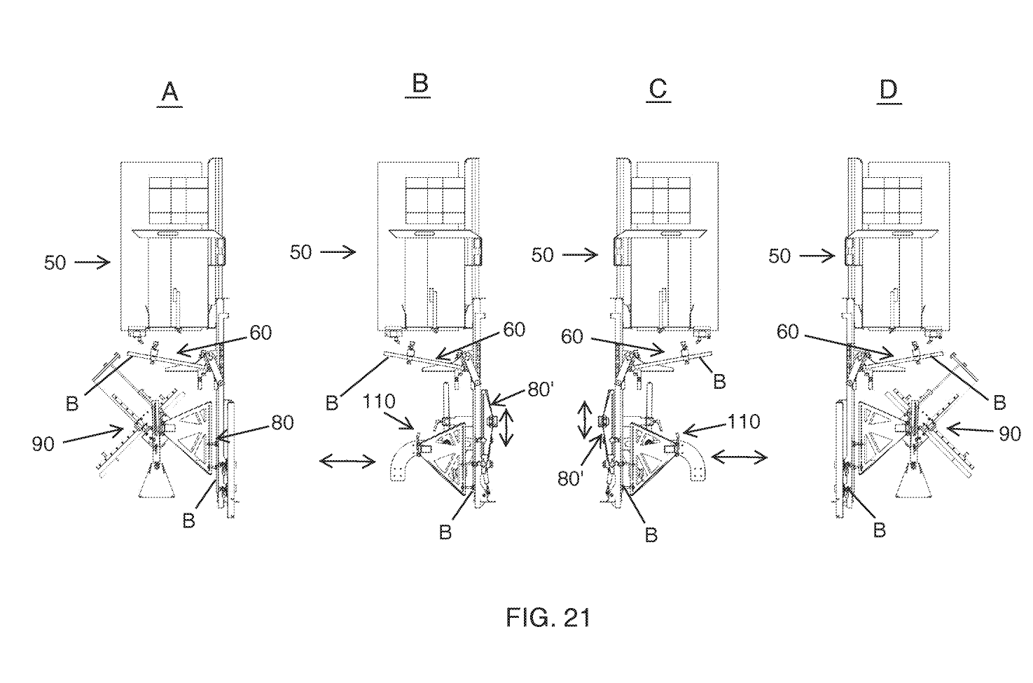

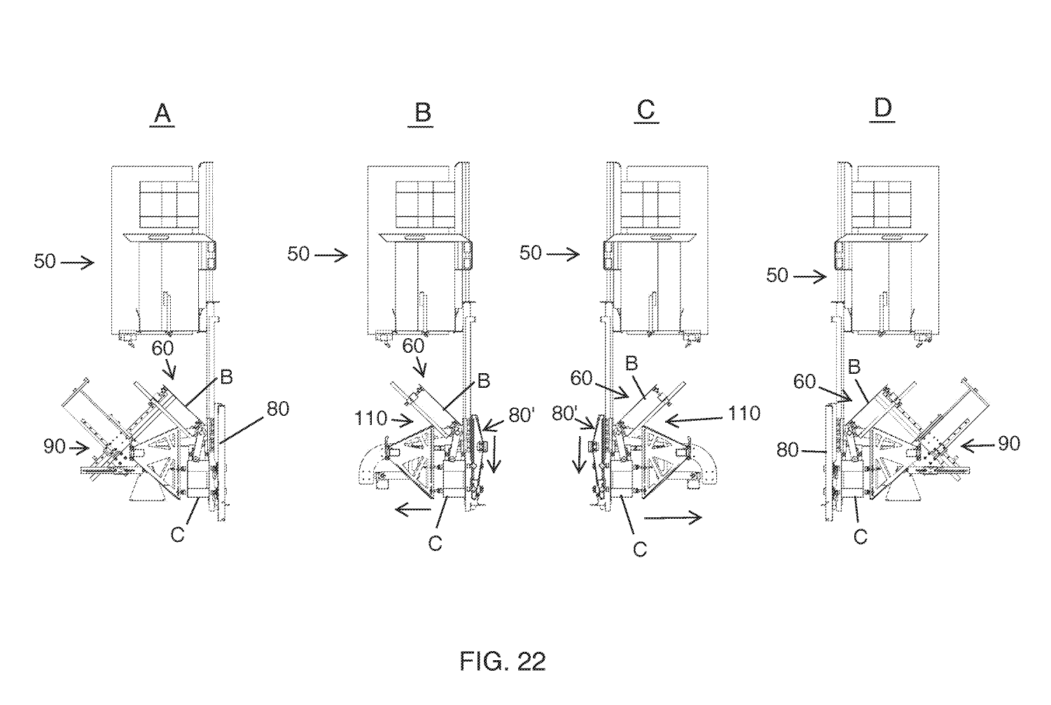

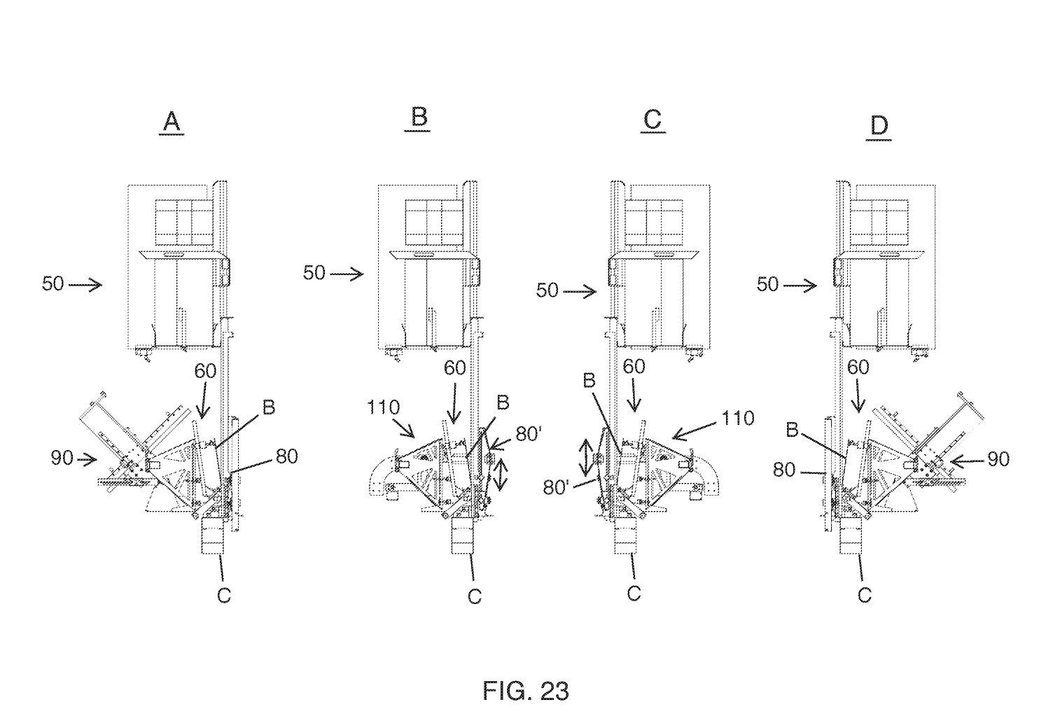

As to the instant disclosure, contemplated, non-limiting modular erectors 30 are generally depicted in FIGS. 2, 3 & 20. Each are fairly and generally characterized by mechanized assemblies, subassemblies, apparatus, etc. to effectuate production of a formed and securingly united case from a case blank. Common elements or features include, but are not necessarily limited to: a frame assembly 40 (FIG. 7) configured to receive the mechanized assemblies, subassemblies, apparatus, etc., some of which may be provided in the alternative as will later be discussed; a magazine 50 (FIG. 8); a transfer assembly or “pull setup” 60 (FIGS. 9 & 10) for delivering a case blank to a case setup area; a case setup area characterized by an operative combination of a case blank clamp 80 and an actuatable case blank expander adjacent thereto, e.g., either of an open setup arc module 90 (FIGS. 2, 13 & 14) or an open setup linear module 110 (FIGS. 3, 11 & 12), and a flap folder/tucker 130 (FIG. 15); and, a sealer or squarer/sealer, e.g., a mandrel/gluer module 140 (FIGS. 3 & 16) or a taper module 160 (FIGS. 2 & 17-19) advantageously characterized by a lugged transfer conveyor. Finally, contemplated case erection, erection/forming operations are depicted with reference to the FIG. 20 module erector (erector process), and in a sequence of processing snap shots (FIGS. 21-23) for four (4) variants of the contemplated modular erector, each illustrating operations upon right and left handed cases, and both clockwise or counterclockwise erection motions.

With general reference to either of FIG. 2, 3, or 20, the following processing areas are noted: blank storage (I); blank transfer and manipulation (II); and, erected case sealing (III).

For the sake of convention and to facilitate subsequent discussion, an operational or process flow direction P is generally indicated, as well as select reference indicia, namely, transverse direction T and longitudinal direction L for the contemplated modular erectors, the process flow direction being the longitudinal direction.

The assemblies, subassemblies, structures, etc. associated with the processing stations are supported by and/or with frame assembly 40 characterized by a great deal of symmetry to allow the assemblies, subassemblies, structures, etc. to be easily configured, reconfigured, and/or switched depending upon the nature of the designated processing application. There are two main sections of frame assembly 40, a case opening station 42 (i.e., area II) and a sealing station 44 (i.e., area III). The setup station is the frame section for magazine 50, the open setup (arc module 90 or linear module 110), flap folder 130 and, pull setup 60 elements. The sealing station 44 is the frame section for gluer 140 or taper 160, and an attendant overhead subassembly 170.

Blank storage is effectuated via inclusion of magazine 50, particulars thereof provided FIG. 8, note also any of the contemplated case erector variants (4) depicted in any of the sequential case blank processing steps of any of FIGS. 21-23. The magazine 50 is generally characterized by a drive or feed mechanism (e.g., a conveyor 52 as shown), for advancing blanks towards and to blank transfer and manipulation area II, and a holder 54, advantageously but not necessarily characterized by, in operative combination, a follower 56, and a hook 58 downstream thereof.

The blanks are positioned and secured in the magazine and as a vertical stack extending in the longitudinal direction L, either of P1 or P2 thereby a visible blank surface as per FIG. 20 wherein a right hand case (i.e., major panel P_{M} to the right of minor panel Pₘ) is shown. Generally, magazine loading operations are characterized by repositioning/relocating the magazine follower via lifting or rotation, while the hook holds the blanks that are already present in the magazine, an introducing a new/additional bundle between the follower and the blanks that are already in the magazine. The hook provides temporary support for the blanks in the magazine while it is being loaded.

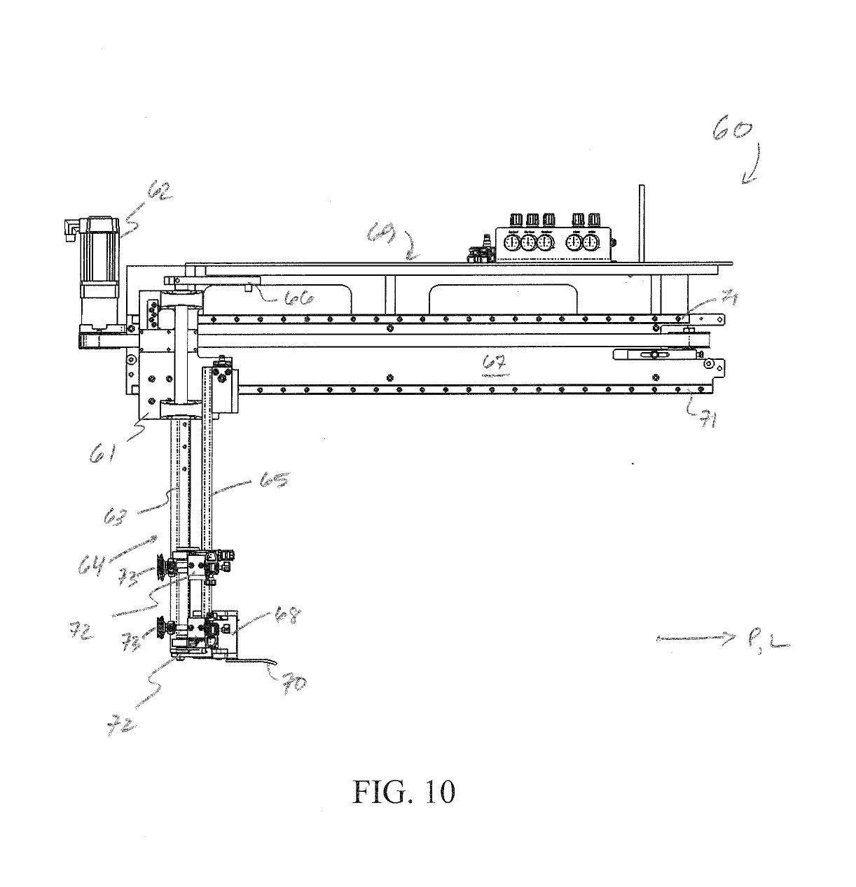

With continued general reference to either of FIG. 2, 3, or 20, blank transfer and manipulation area II is commonly characterized by blank transfer assembly 60, case blank clamp 80 and an actuatable blank expander 90, 110 to effectuate the functions of transfer and manipulation. Of the two functions, the initial transfer function is now taken up with general reference to the figures indicated, as well as with specific select reference to either of FIG. 9 or 10.

A transfer assembly, advantageously in the form of a “pull setup,” is generally provided for. The transfer assembly 60 includes five advantageous components as shown: a servo drive system/motor 62, a pivoting vacuum cup assembly 64, a cam 66, a pusher 68, and a trailing minor hold-up ski 70. Notionally, the pivoting vacuum cup assembly grabs or otherwise secures a single, downstream most case blank from the magazine and sets it in place for subsequent opening/expansion. The pull setup also advances an erected and initially formed case from the setup station to the sealing station, and holds up the folded trailing (i.e., upstream) minor flap.

Structurally, the assembly 60 is characterized by a translatable transfer assembly carriage 61, equipped with first 63 and second 65 support structures, a longitudinally extending brace 67 extending between spaced apart frame elements which delimit the longitudinal extent of the open set up station, and an over head guide 69 for directing (i.e., rotating) first support structure 63. The carriage 61, as shown (FIG. 10) is supported by rails 71 carried by brace 62. The first support structure 63, part of a pivoting vacuum cup assembly or subassembly 64, is adapted to carry spaced apart arms 72, each arm equipped with actuatable vacuum cup sets 73. One or both of the arms may be vertically adjustable, with at least a single cup of each of what is essentially upper and lower cup sets being horizontally adjustable. The first support structure 63 is rotatably supported at carriage 61, with an upper free end adapted to permit first support structure travel with respect to cam 66 of overhead guide 69 in furtherance of effectuating a pivot rotation for vacuum cup arms 72 as carriage 61 is longitudinally driven downstream by electromechanical drive linkage 62 as shown. The second support structure 65, downstream of first support structure 63, downwardly extends from carriage 61 and includes, at a free end thereof, pusher 68 and ski 70. The pusher generally extends in a transverse direction, with the ski generally extending in a longitudinal direction.

Functionally, the pivoting vacuum cup assembly is actuatable and driven by a servo motor of the electromechanical drive linkage so as to rotate and move towards the magazine until the pivoting vacuum cup assembly is parallel and in a spaced apart condition relative to the magazine (i.e., the assembly is actuated so as to extend in the transverse direction; see FIG. 10). The rotating movement is created or effectuated via use of cam (FIG. 9). When the pivoting vacuum cup assembly is parallel to the magazine, air cylinders on the assembly extend and the vacuum turns on causing the assembly to grab the case blank. Thereafter, the pivoting vacuum cup assembly moves the case blank to the setup station where the blank is received by a case blank clamp (see e.g., FIG. 20, or any of the operational sequences of the erector variants of FIGS. 21-23). More particularly, and notionally, the blank is repositioned longitudinally downstream, and in an orientation 90 degrees from its starting position (i.e., blank extension from a transverse direction orientation (blank magazine position) to a longitudinal direction orientation (case blank clamp position); as per FIG. 20, a distal edge of the blank is pulled out longitudinally of a blank retainer to permit the proximal edge to slide transversely, the distal edge thus delimiting a downstream most blank edge, the proximal edge thus delimiting an upstream most blank edge. As the case blank is expanded in the open setup operation, pusher moves the case to the sealing station while the trailing minor hold up ski holds up the minor flap.

Prior to discussion of the open setup, it is to be noted that the case blank could be grabbed through other methods. Moreover, the picker assembly could be moved through use of other drive systems, with contemplated motions readily programmed instead of created through the use of a cam.

With renewed general reference to either of FIG. 2, 3, or 20, and having discussed transfer operations characteristic of blank transfer and manipulation area II, attention is now directed to manipulation operations, more particularly, modules, assemblies, subassemblies, apparatus, etc. for effectuating same. The case set up area or station of the contemplated erectors are commonly characterized by case blank clamp 80, an actuatable blank expander 90, 110 to effectuate manipulation, more particularly, blank opening, and a flap folder/tucker. In advance of a presentation of alternatives, some preliminary discussion is warranted.

As should be at least implicit relative to the background and disclosure to this point, mechanized case erection includes parameter or constraints relative to the nature of the case itself, namely, the nature of the blank. In lieu of a robust, highly mechanized, expensive one size fits all approach, Applicant has, among other things, focused upon a case erection solution characterized by modularity. More particularly, within a set framework (i.e., FIG. 7), select assemblies or subassemblies are opertaively supportable and supported. With general provisions for executing select sealing operations, i.e., taping (e.g., FIG. 2) or gluing (e.g., FIG. 3) contemplated case blank erector operations, namely, open setup, are a function of case handedness and a direction of case opening, i.e., clockwise or counterclockwise. As best seen with reference to FIGS. 21-23, a first modular solution (i.e., arc setup as per FIG. 13) effectuates counterclockwise LH case setup (e.g., FIG. 21, A) and clockwise RH case setup (e.g., FIG. 21, D), with a second modular solution (i.e., linear setup as per FIG. 11) effectuating clockwise RH case setup (e.g., FIG. 21, B) and counterclockwise LH case setup (e.g., FIG. 21, C). Linear setup details follow, with arc setup details thereafter.

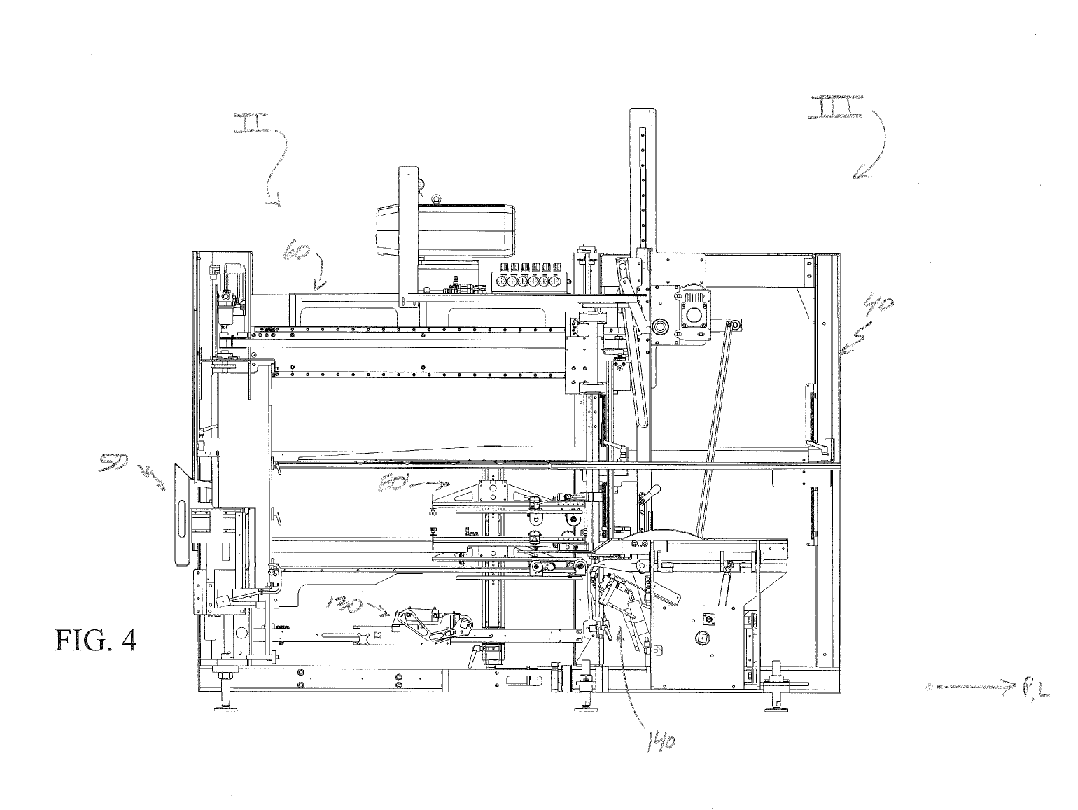

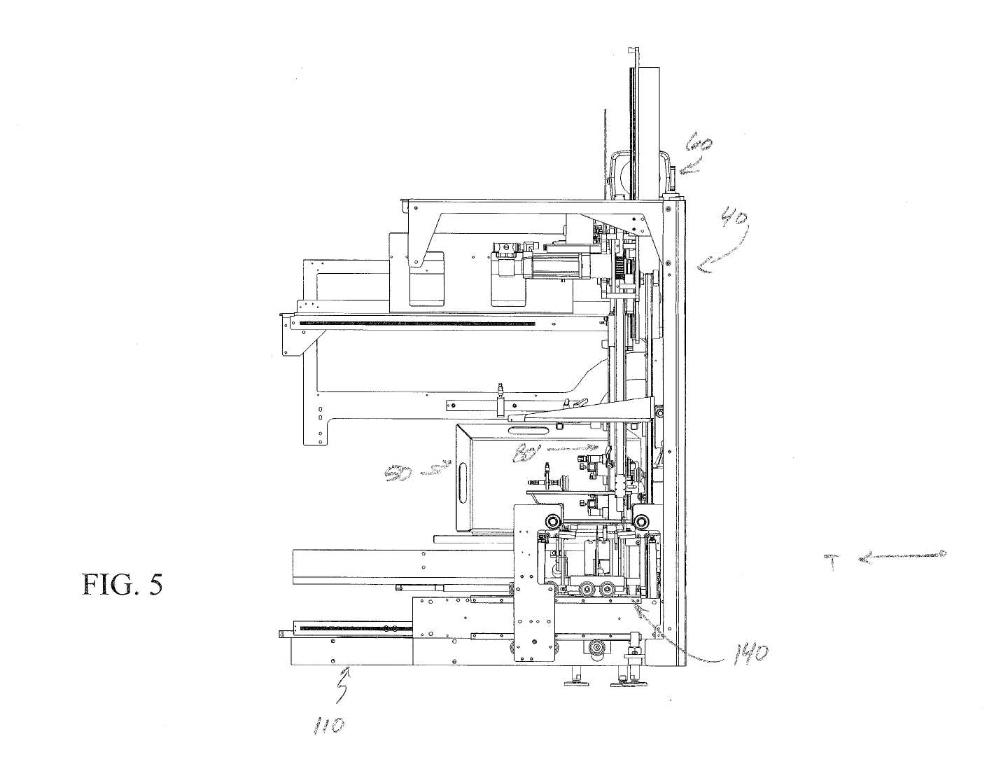

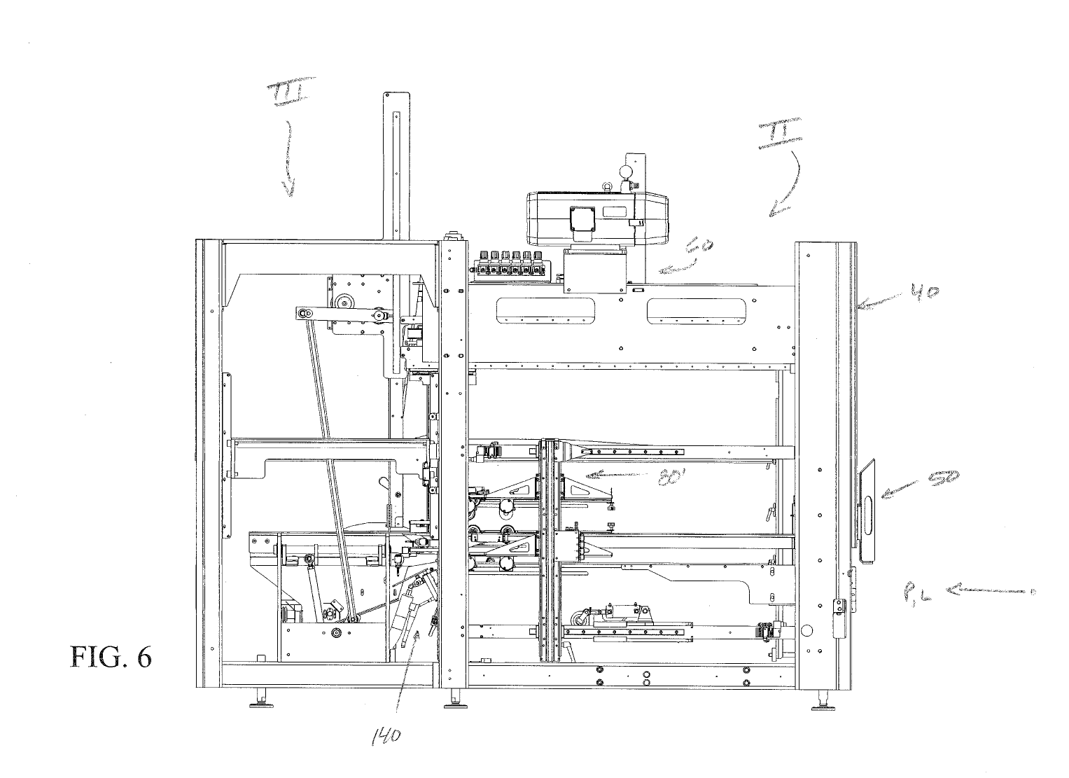

With renewed general reference to FIGS. 3-6, and particular reference to FIGS. 11 & 12, primary components of a case setup area are shown, namely, an operative combination of case blank clamp 80 and an actuatable case blank expander 90, 110 adjacent thereto.

More particularly, a linear setup is illustrated, namely, a setup characterized by a translatable case blank clamp, more particularly, a longitudinally translatable case blank clamp 80′, and a translatable blank expander, more particularly, a transversely translatable blank expander 110. Notionally, the blank expander is actuated so as to approach a clamped case blank held in the case blank clamp and attach to a side of the blank, thereafter, the expander retracts while the clamped case blank is longitudinally advanced (downstream) in furtherance of case setup. A clockwise (series B FIGS. 21-23) or counterclockwise (series C FIGS. 21-23) case opening is thereby effectuated.

As best appreciated with reference to FIGS. 11 & 12, case blank clamp 80′ of the linear setup is present as a rail mounted carriage assembly. Upper and lower longitudinally extending rails 81 are supported upon longitudinally extending, spaced apart upper and lower frame elements 82. A clamp carriage 83 is supported thereon for reversible translation, and is actuatable and driven in known ways, for example and without limitation, as by a pneumatic drive linkage.

Clamp carriage 83, as shown, generally includes upper and lower arms 84, each arm equipped with actuatable vacuum cup sets 73, the cups of each set supported in a longitudinally spaced apart condition. While the cups of the upper vacuum cup set attach to the major blank panels, the cups of the lower vacuum cup set attached to the lower major blank flap. As is characteristic of many elements of the contemplated modular erector, adjustability is a necessity in relation to operational versatility, in the present mechanism, the vertical spaced apart arm condition is adjustable as is the horizontal spaced apart condition for and between cups of a vacuum cup set.

Actuatable case blank expander 110 imparts a transverse force upon the clamped blank of the case blank clamp. Expander 110, like clamp 80′ in the subject case setup area, is present as a rail mounted carriage assembly. A frame mounted support member 111 transversely spans longitudinally extending lower frame members which generally delimit the width of the case setup area. As shown (FIG. 11), spaced apart transversely extending rails 112 are supported upon/by the frame mounted support member 111, with an expander carriage 113 operatively carried upon rails 112 for reversible translation, carriage 113 actuatable and driven in known ways, for example and without limitation, as by an electromechanical drive linkage as shown.

Expander carriage 113, as shown, generally mimics the clamp carriage and likewise includes upper and lower arms 114, each arm equipped with actuatable vacuum cup sets 73, the cups of each set supported in a longitudinally spaced apart condition. While the cups of the upper vacuum cup set attach to the major blank panels, the cups of the lower vacuum cup set attach to the lower major blank flap. As is characteristic of many elements of the contemplated modular erector, adjustability is a necessity in relation to operational versatility, in the present mechanism, the vertical spaced apart arm condition is adjustable as is the horizontal spaced apart condition for and between cups of a vacuum cup set.

With renewed reference to FIG. 2, and particular reference to FIGS. 13 & 14, primary components of an alternately equipped case setup area are shown, namely, an operative combination of a case blank clamp and an actuatable case blank expander adjecent thereto. More particularly, an arc setup is illustrated, namely, a setup characterized by a fixed or static case blank clamp 80, and an actuatably actuatable case blank expander 90. Notionally, the instant blank expander is actuated so as to arcuately approach a clamped case blank held in the fixed case blank clamp, from a distal most case setup area locus, and attach to a side of the blank at a proximal most case setup area locus, thereafter, the expander retracts in furtherance of case setup. A counterclockwise (series A FIGS. 21-23) or clockwise (series D FIGS. 21-23) case opening is thereby effectuated.

As best appreciated with reference to FIGS. 13 & 14, case blank clamp 80 of the arc setup is present as spaced apart upper and lower subassemblies 85. Each subassembly 85 of clamp 80 is advantageously but not necessarily characterized by a longitudinally extending, frame supported member 86, each member equipped with actuatable vacuum cup sets 73. As shown, the vacuum cups sets of the upper assembly (i.e., upper vacuum cups) are indirectly mounted to the frame supported member so as to be vertically adjustable, e.g., the cups are adjustably supported (vertically) upon an arm, the upstream arm associated with the upstream most vacuum cup being longitudinally adjustable relative to a longitudinally fixed downstream arm. With regard to the vacuum cup sets of the lower assembly (i.e., lower vacuum cups), the upstream vacuum cup is carried upon its frame supported member so as to be longitudinally adjustable relative to a longitudinally fixed downstream vacuum cup. While the cups of the upper vacuum cup set attach to the major blank panels, the cups of the lower vacuum cup set attach to the lower major blank flap.

Actuatable case blank expander 90 imparts both transverse and longitudinal force, simultaneously, upon the clamped blank of the fixed case blank clamp. The expander of this case setup area, as that of the case setup area of, for example, FIG. 3 is likewise present as a rail mounted carriage assembly. Notionally, while the carriage assembly is reversibly driven through the case set up area in a first diagonal direction, a subassembly thereof is respondingly driven through the case setup area in a second diagonal direction via a pivot linkage.

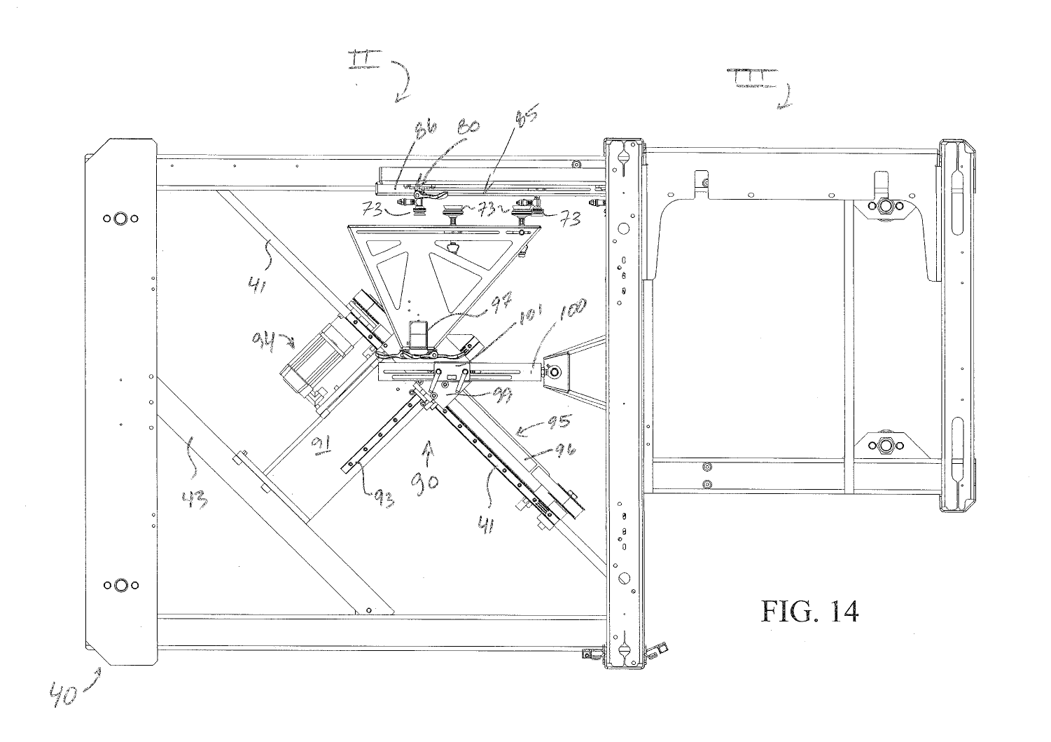

With continued reference to FIGS. 13 & 14, arc setup expander 90 is present as a rail mounted carriage assembly. An assembly base 91 is translatably mounted upon a rail 92 which in turn is mounted or otherwise supported by an internal frame member 41 which traverses a “floor” of the case set up area, more particularly, an internal frame member extending from an upstream portion of a “rear” longitudinally extending frame member and to a forward portion of a downstream transversely extending frame member (FIG. 14). As shown, a portion of base 91 opposite the rail supported portion is adapted for translation in relation to a further internal frame member 43, namely, one spaced apart and parallel from rail supporting member 41 as shown. Moreover, a further rail segment 93 is supported by assembly base 91 as shown.

An electromechanical drive assembly 94 operatively unites expander assembly base 91 with rail supporting member 41 so as to direct assembly base 91, and thus the expander assembly per se, in the indicated reversible travel direction. Drive assembly 94 is advantageously, but not exclusive characterized by a servo motor 95 and power transmission subassembly 95 characterized by an operatively supported belt 96 or the like as indicated.

Arc setup expander 90 further includes a post 97 adapted to adjustably receive and support spaced apart arms, namely, upper and lower arms, for example, upper and lower brackets 98 as shown (FIG. 13). Each arm or bracket 98, in keeping with the instant disclosure, is equipped with actuatable vacuum cup sets 73, the cups of each set adjustably supported in a longitudinally spaced apart condition. While the cups of the upper vacuum cup set attach to the major blank panels, the cups of the lower vacuum cup set attached to the lower major blank flap, with both vertical arm and longitudinal vacuum cup adjustability enabling the processing of numerous case blank sizes.

A base 99 of post 97 is adapted to be translatingly received upon rail 93 of the rail mounted carriage assembly. A pivot arm 100 is further provided, and operatively links post base 99 to/with a transversely extending downstream most frame member delimiting the case setup area. More particularly, pivot arm 100 is offsettingly anchored upstream of the frame member, and intermediate the front and rear portions of the case set up area, for pivot motion responsive to translation of rail mounted carriage assembly base 91. Pivot arm 100 is adapted, as by the inclusion of a slot or the like, to relocatingly receive a holder, e.g., a selectively tensionable anchor or clamp 101 which extends from the post base 99 so as to operably unite the pivot arm with the carriage subassembly. It should be appreciated that the variable anchoring local for the holder in relation to the pivot arm anchor point greatly facilitates a wide assortment of blank/case sized to be processed in keeping with operational objectives and desires.

With limited particular reference now to FIG. 15, while contextually referencing any of the exemplary erectors of FIG. 2, 3 or 20, there is generally shown flap folder/tucker apparatus or subassembly 130 for manipulating minor flaps of the partially formed case. The flap folder/tucker resides within the case set up area or station of the erector as is generally shown (FIGS. 2, 3 & 20). Leading flap folders 132 are supported upon a transversely extending arm 134, at least one folder being adjustable in the transverse direction. Trailing flap folders 136 are likewise supported upon a transversely extending arm 138, at least one folder being adjustable in the transverse direction. Arms 136, 138 extend from a longitudinally extending brace or structural member part-and-parcel of the frame assembly, the leading arm supported downstream of the trailing arm.

Having detailed primary assemblies, subassemblies, apparatus, structures, etc. for the case set up station, focus turns next to the remaining operations of transfer from the setup station to the sealing area or station and erected case sealing. A general discussion of sealing operations follows a brief description of downstream transfer operations.

In addition to initiating case forming operations via a transfer of a case blank from the magazine to the case blank clamp, the transfer assembly (FIGS. 9 & 10) operates to advance a partially erected case to the sealing station. More particularly, owing to its arrangement in relation to the pivotable/rotatable arm, the pusher acts upon a formed case, pushing is downstream, with the ski of the assembly engaging (i.e., holding up) the trailing folded minor flap while upstream the transfer arm positions a blank within the case blank clamp.

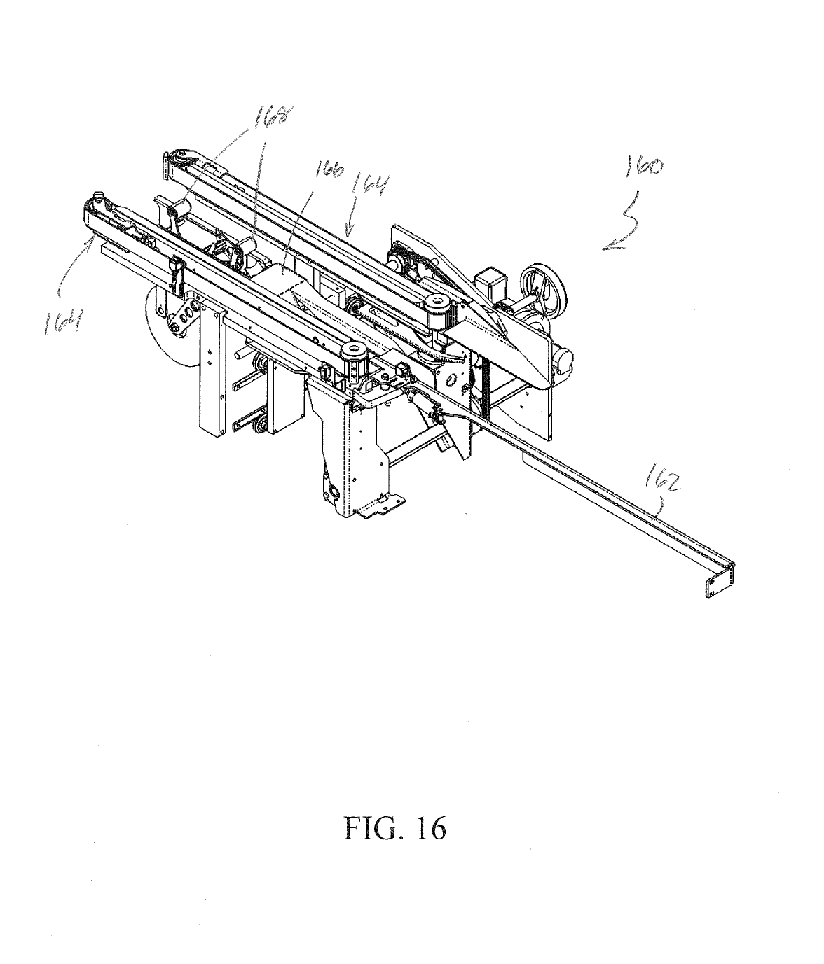

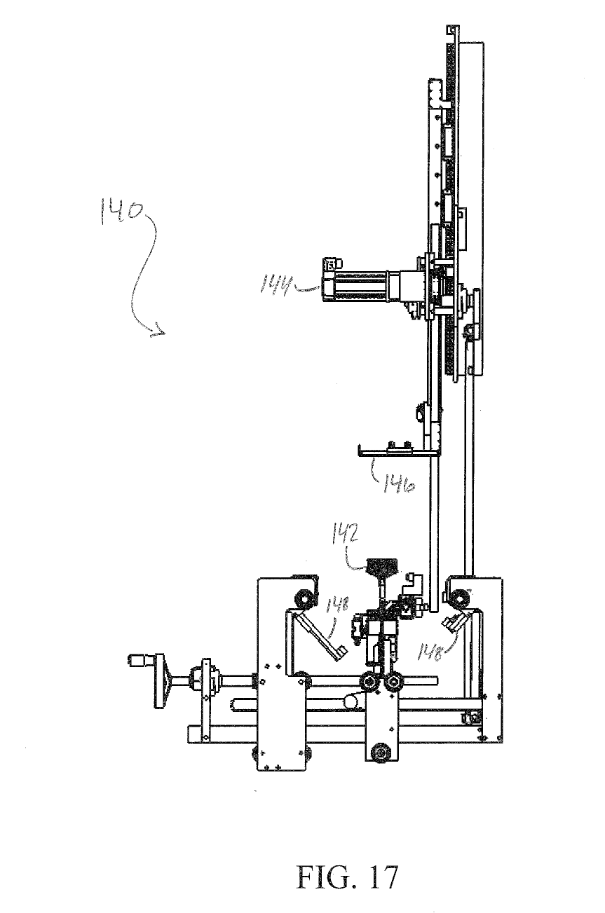

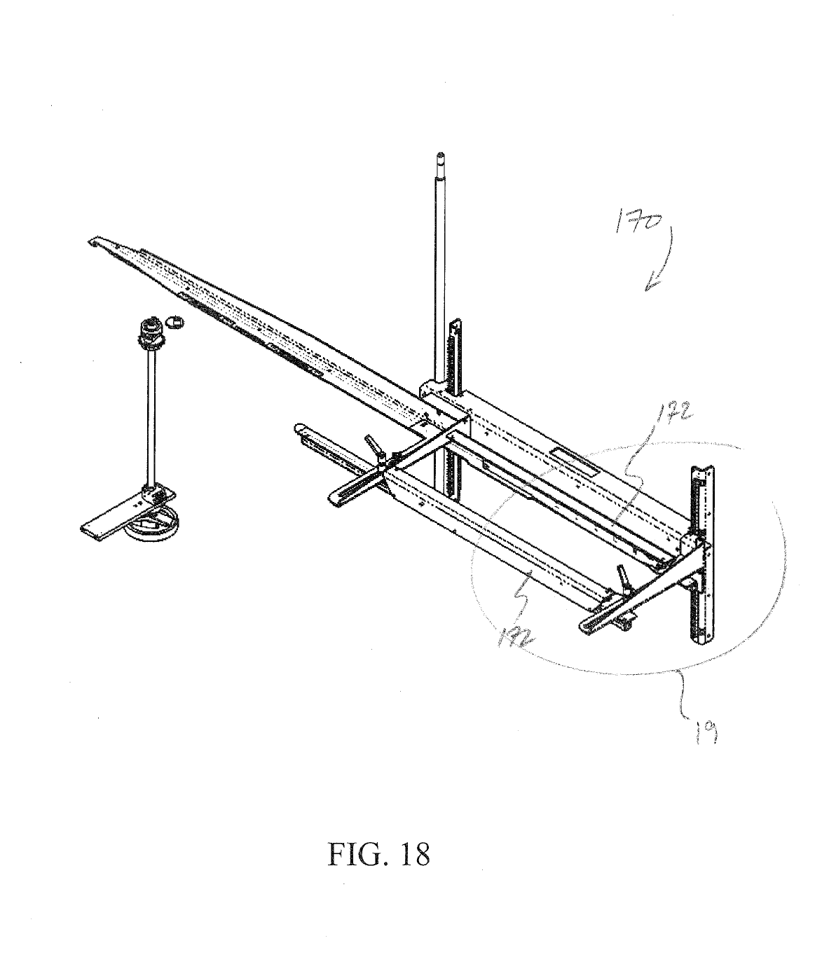

In connection to sealing operations, and in advance of a brief overview of modular taper 160 (FIG. 16) and modular gluer 140 (FIG. 17), common preliminary operations are noted. Folded minor flaps of the case remain engaged in advance of and so as to readily permit the folding of major flaps as a condition precedent to sealing the formed case “bottom” in the sealing station. Moreover, overhead assembly 170 (FIGS. 18 & 19) holds down the partially formed case and controls the case as it proceeds from the setup station to and through the sealing station.

With reference now to FIGS. 2 & 16, a non-limiting advantageous taper is illustrated. Taper 160 folds the major flaps and seals the case. This taper was designed to be interchangeable with the compression glue assembly.

As the case is pushed into the sealing station, a center rail 162 centrally and longitudinally extends and generally delimits a taper ingress. Rail 162 functions to hold up the minor flaps of passing cases just long enough to partially/initially fold the major flaps up. The rail is long enough to effectuate partial base formation, but not so long as to create excessive drag. Thereafter, the case is further advanced to a tangent point of paired lug belts 164, i.e., a lug belt ingress, where lug belts 164 take over from pusher 68 of transfer assembly 60 and finish folding the major flaps by pushing the case over a major flap plow 166, and then over a tape head 168 selectively dispensing tape across the abutting major flaps, thereby sealing the case base or bottom.

In the context of sealing operations, especially so in the context of a sealing station characterized by a taper, the overhead (FIGS. 18 & 19) functions to downwardly urge the case and stabilize same as it advances through the station. More particularly, the overhead is used to ensure the tape gets good adhesion by ensuring that the case is where it is supposed to be during tape affixation. Spring loaded rails apply pressure on a case passing thereunder to push it against the tape head while squaring the case up in advance of sealing same. This is important because the cases sometimes vary in size slightly and this ensures quality tape adhesion.

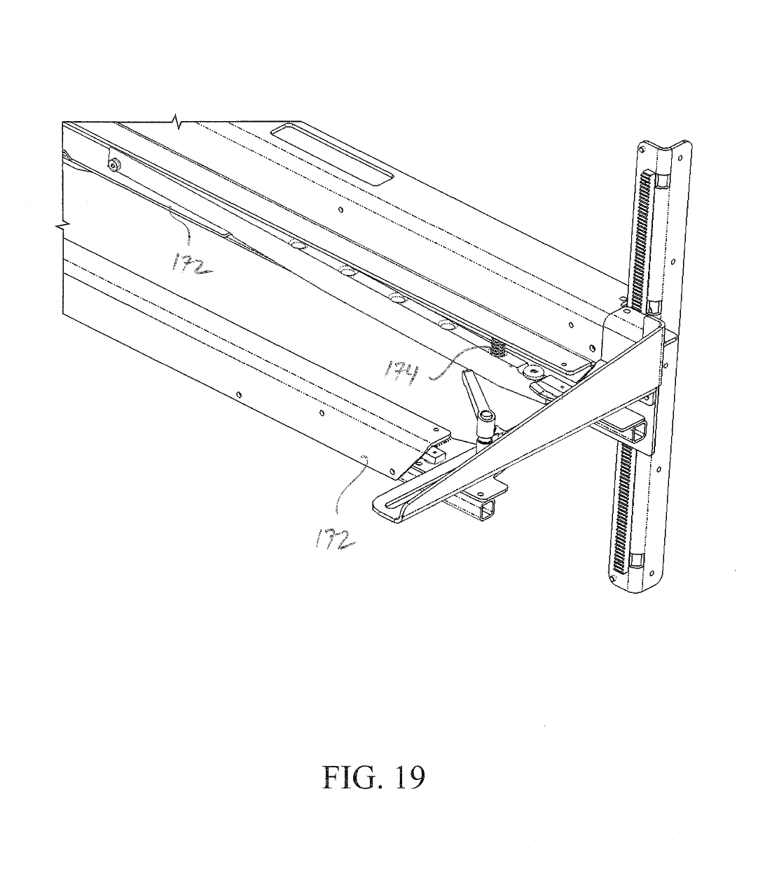

Overhead 170 is generally characterized by two longitudinally extending rails 172. A first rail is a “rear” fixed rail, a second rail is an adjustable rail. The rails are vertically adjustable, the second rail transversely adjustable relative to the first rail. As noted with reference to FIG. 19, the rails are adapted, as by operative inclusion of a spring 174, to tensioningly receive upper case portions passing thereunder/through, the tensioning being particularly advantageous at the lug belt ingress to aid in stabilization in this processing transition.

With reference now to FIGS. 3 & 17, a non-limiting advantageous gluer is illustrated. More particularly, a compression glue assembly 140 selectively glues the case flaps together to seal the case. This compression glue assembly was designed to be interchangeable with the taper.

As the case is pushed into the sealing station, its location is sensed, and glue heads 142 apply glue directly on the minor flaps. Thereafter, a servo motor 144 drives a mandrel 146 towards the case top opening and into the case. At the same time lower compression plates 148 are actuated to pinch the flaps together in compression in furtherance of glue to adherence.

Having provided an overview of the erector and its characteristic assemblies, subassemblies and structures, an exemplary operative overview is provided in conclusion. The case erector starts erecting a case subsequent to the operator loading blanks in the magazine. The magazine uses the magazine follower, which the operator places behind the blanks, along with the magazine bed to maintain blanks as ready to be picked up. Those blanks are then sequentially grabbed by the pull setup, specifically the pivoting vacuum cup assembly. This assembly grabs one blank and places it in the setup station where it is opened by either the open setup arc version or the open setup linear version. If the arc version is used the adjustable side cups use an arc motion to open the case blank, and if the linear version is used the adjustable side cups use a linear motion perpendicular to the fixed side vacuum cup that is also moving at the same time, to open the case blank. While the blank is being opened the major flaps are also being opened with the same opener system, this is done by simply offsetting the cups that attach to the flaps when compared to those attached to the body of the case. While these flaps are held open the flap folders fold and hold the minor flaps until the case is moved by the pusher onto the trailing minor hold up ski. The pusher continues pushing the case into the sealing station, which is either the taper or the compression glue assembly. For the taper the case is pushed into the sealing station and the major flap plow closes the major flaps and then the lug belts push the case over the tape head while the overhead element holds down the case with the fixed rails and the adjustable rails. If the cases are to be sealed with the compression glue assembly, again the cases are pushed into the sealing station and the glue heads apply glue directly onto the minor flaps. Then the mandrel lowers into the case. Then the lower compression plates are driven into place and pinch all the flaps to allow the glue to adhere them together. When the case has been sealed, the next case pushes the first one out of the sealing station. The frame supports all of these elements and is easily reconfigured to allow for different elements to be used such as taper or compression glue or the different open setup versions. It also allows for changes due to case size or type and can be set up as right handed or left handed.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What is claimed is:

1. In a case erector, a case set up station comprising:
a. a transfer assembly for securing a vertically oriented case blank from a supply of vertically oriented case blanks and delivering a secured case blank to a case blank clamp while maintaining a vertical orientation for the case blank;
b. a case blank clamp downstream from the supply of vertically oriented case blanks and extending in a process flow direction for holding a delivered case blank, said case blank clamp characterized by first upstream and second down stream vacuum cup pairs, a first surface of a delivered case blank engaged by said first upstream and second down stream vacuum cup pairs; and,
c. an actuatable case blank expander adjacent said case blank clamp, said actuatable case blank expander actuatable so as to travel towards and away from a held case blank of said case blank clamp, said actuatable case blank expander securable to a second surface of the delivered case blank held by said case blank clamp during a first actuation motion, the second surface of the delivered case blank held by said case blank clamp pulled away from the first surface of the delivered case blank held by said case blank clamp during a second actuation motion.

2. The case set up station of claim 1 wherein said transfer assembly is characterized by a pivotable arm adapted to secure the vertically oriented case blank from a supply of vertically oriented case blanks.

3. The case set up station of claim 1 wherein said transfer assembly is characterized by a translatable arm adapted to secure the vertically oriented case blank from a supply of vertically oriented case blanks.

4. The case set up station of claim 1 wherein said transfer assembly is characterized by an arm adapted to secure the vertically oriented case blank from a supply of vertically oriented case blanks, said arm being pivotable in a transverse direction.

5. The case set up station of claim 1 wherein said transfer assembly is characterized by an arm adapted to secure the vertically oriented case blank from a supply of vertically oriented case blanks, said arm being translatable in a longitudinal direction.

6. The case set up station of claim 1 wherein said transfer assembly is characterized by an arm adapted to secure the vertically oriented case blank from a supply of vertically oriented case blanks, said arm being pivotable in transverse direction and translatable in a longitudinal direction.

7. The case set up station of claim 1 wherein said transfer assembly is characterized by an actuatable arm and a single actuator, said actuatable arm actuatable via said single actuator so as to reversibly travel between a downstream most vertically oriented case blank of the supply of vertically oriented case blanks and said case blank clamp.

8. The case set up station of claim 1 wherein said transfer assembly is characterized by an actuatable arm and a single actuator, said actuatable arm actuatable via said single actuator so as to reversibly travel between a downstream most vertically oriented case blank of the supply of vertically oriented case blanks and said case blank clamp, said reversible travel characterized by both transverse and longitudinal travel direction components.

9. The case set up station of claim 1 wherein said actuatable blank expander is adjacent said case blank clamp in a transverse direction.

10. The case set up station of claim 1 wherein travel towards and away from a held case blank of said case blank clamp by said actuatable case blank expander is characterized a transverse travel direction component.

11. The case set up station of claim 1 wherein travel towards and away from a held case blank of said case blank clamp by said actuatable blank expander is characterized by a longitudinal travel direction component.

12. The case set up station of claim 1 wherein travel towards and away from a held case blank of said case blank clamp by said actuatable blank expander is characterized by both longitudinal and transverse travel direction components.

13. The case set up station of claim 1 wherein said actuatable blank expander is pivotably retained relative within the case set up station such that actuation effectuates travel towards and away from a held case blank of said case blank clamp in both longitudinal and transverse travel direction components.

14. The case set up station of claim 1 wherein said case blank clamp is translatably supported within a portion of the case set up station in relation to said actuatable case blank expander.

15. The case set up station of claim 14 wherein travel towards and away from a held case blank of said case blank clamp by said actuatable blank expander is characterized by travel in a transverse travel direction.

16. The case set up station of claim 1 wherein said case blank clamp is fixedly supported within a portion of the case set up station in relation to said actuatable case blank expander.

17. The case set up station of claim 16 wherein travel towards and away from a held case blank of said case blank clamp by said actuatable blank expander is characterized by travel in both a transverse and longitudinal travel directions.

18. The case set up station of claim 1 wherein each of said transfer assembly and said actuatable case blank expander is characterized by a single electromechanical subassembly to effectuate delivery of a secured case blank to the case blank clamp, and to effectuate each of said first and said second actuation motions respectively.

19. The case set up station of claim 1 further comprising a flap tucker assembly underlying said actuatable case blank expander, said flap tucker operable during said second actuation motion for said actuatable case blank expander to effectuate lower flap tucking.

20. The case set up station of claim 1 further comprising a sealing assembly for sealing a base of an expanded partially erect case, said sealing assembly downstream of said actuatable case blank expander.

21. The case set up station of claim 1 further comprising a sealing assembly for sealing a base of an expanded partially erect case, said sealing assembly downstream of said actuatable case blank expander, said sealing assembly characterized by a taper.

22. The case set up station of claim 1 further comprising a sealing assembly for sealing a base of an expanded partially erect case, said sealing assembly downstream of said actuatable case blank expander, said sealing assembly characterized by a gluer.
